(19) United States
(12) Patent Application Publication
(10) Pub. No.: US 2024/0129289 A1
(43) Pub. Date: Apr. 18, 2024

(54) USER CERTIFICATE WITH USER AUTHORIZATIONS

(71) Applicant: Beyond Identity Inc., West Palm Beach, FL (US)

(72) Inventors: Jasson CASEY, West Palm Beach, FL (US); Thomas JERMOLUK, West Palm Beach, FL (US)

(21) Appl. No.: 18/376,267

(22) Filed: Oct. 3, 2023

Related U.S. Application Data
(60) Provisional application No. 63/416,266, filed on Oct. 14, 2022.

(51) Int. Cl. H04L 9/40

(52) U.S. Cl. CPC H04L 63/0823; H04L 63/10

(57) ABSTRACT

In embodiments, a user device stores a certificate that both identifies the user and indicates what the user is authorized to access. When access is desired, the certificate is provided. Instead of a user login and password, the signed certificate functions to identify the user (and also the user device). Instead of separately accessing an administrator table to verify whether the user is authorized to access the website or program or other resource, the certificate on the user device is consulted.

This application claims priority to U.S. Provisional Patent Application No. 63/416,266, filed Oct. 14, 2022, and entitled “USER CERTIFICATE WITH USER AUTHORIZATIONS,” the contents of which are hereby incorporated by reference in their entirety for all purposes.

### BACKGROUND OF THE INVENTION

The present invention relates to user certificates and access authorizations.

Currently, access control to a computer system or website is a two-step process. First, a user login and password is required at a server or other computer. Two factor authentication may also be used. Second, for access to particular resources, the user must be listed in an access database typically controlled by an administrator. The increase in working remotely has vastly increased the use of such remote log-ins and the concurrent security risks.

Websites and user devices communicate using certificates that identify and authenticate the website or device. A device typically has its certificate entered at the factory. Websites can be authenticated by third party certificate authorities. For example, one common type of certificate is an X.509 certificate, which has a digital signatory. The signatory itself must also have a certificate, which has a second signatory, or be self-signed. And that second signatory possesses a certificate with a third signatory, and so forth, leading to a chain of certificates. Starting with a root signatory, each certificate signs the next until reaching the server's (end entity) certificate, which is the last (“leaf”) certificate (the certificate used to access a website server). A leaf certificate cannot be used to sign other certificates. According to the TLS protocol, this chain starts with a self-signed certificate, which is from a single, universally-trusted root. This trusted root certificate has been included in a select group of root Certificate Authority (CA) certificates. Any CA in this select group can sign other certificates. The select group can vary in size, but membership is determined by a consortium of browser vendors, Operating Systems vendors, and Certificate Authorities called the CAB Forum.

### BRIEF SUMMARY OF THE INVENTION

In embodiments, a user device stores a certificate that both identifies the user and indicates what the user is authorized to access. When access is desired, the certificate is provided. Instead of a user login and password, the signed certificate functions to identify the user (and also the user device). Instead of separately accessing an administrator table to verify whether the user is authorized to perform an action in or access a controlled digital asset (e.g., a program, website or database), the certificate on the user device is consulted.

In embodiments, the credential with the authorizations is written to Hardware Security Module (HSM) on the user device and locked, so it cannot be exported and thus cannot be tampered with. This means that it cannot be changed, so when an authorization changes, a new certificate is simply generated and added to the HSM. The new certificate in one embodiment overwrites the old one. In another embodiment, a revocation list can also be used to invalidate certificates in use cases where the update process is not trusted In one embodiment, multiple authorizations are written to the same certificate. In another embodiment, a separate certificate is used for each authorization. Alternately, a mix of single and multiple authorizations could be used.

In embodiments, multiple types of certificates are supported. A normalization engine converts all authorizations into a standard set of fields. Those fields are then mapped to different types of certificates, depending up which type of certificate is supported to a particular website or application or other resource the user is trying to access. For example, certificates including X.509, SSH, OpenPGP, SPKI, and other certificate formats that support “authorizations” or “extensions”/“options,” are supported.

### BRIEF DESCRIPTION OF THE DRAWINGS

FIG. 1 is a diagram illustrating a typical prior art remote user work environment.

FIG. 2A is a diagram illustrating a remote user work environment with an added platform authenticator according to an embodiment.

FIG. 2B is a diagram illustrating the remote user work environment of FIG. 2 with a Single Sign-On (SSO) provider according to an embodiment.

FIG. 3 is a flowchart illustrating the assignment of authorizations to a user certificate according to an embodiment.

FIG. 4 is a diagram illustrating the components of a platform authenticator according to an embodiment.

FIG. 5 is a diagram illustrating the fields of a certificate according to an embodiment.

FIG. 6 is a diagram of the certificate extension fields storing authorizations and other organization data.

FIG. 7 is a simplified block diagram of a representative computing system and client computing system usable to implement certain embodiments of the present invention.

### DETAILED DESCRIPTION OF THE INVENTION

In embodiments, a certificate is created for a user that both (1) uniquely identifies the user without the need for a logon or password, and (2) indicates what systems the user is authorized to access. The actions that the user on the device is authorized take on an asset, and the obligations or conditions that must be met by the user and device, enforced by a platform authenticator (PA) and the accessing service, for those authorizations to remain valid. The certificate can be signed by (a) the computer system being accessed, (b) a 3^{rd} party certificate authority, or (c) can be a self-signed certificate by the user device. The user device stores the certificate, and stores the associated private key in the HSM, where it cannot be retrieved. When access is desired, the certificate is provided along with proof of ownership of the key via a challenge by the service and a signed assertion response from the HSM. Authorizations can include privileges, roles (one role can define a set of privileges), profiles and resource limitations (e.g., amount of memory usable).

In embodiments, the obligations are proof obligations that require the return of proof attestations showing that the user device and user are indeed the ones that have been given the relevant authorizations.

Examples of Proof Obligations are the following:
The user can demonstrate control of a cryptographic credential.
The user can demonstrate control of a cryptographic credential protected by a ping and/or biometric.
The cryptographic credential is protected by TPM2 hardware, and SGX enclave, etc.
The cryptographic credential is an AA1|2|3 credential.
the registry/plist key X has value Y, the registry/plist key X exists/does not exist.
The process/file name X, or filehash X, exists or does not exist.
The enumerated disks available and their encryption status.
The network security state, presence/absence of certain rules/hooks.
The operating system, bootloader, bios, application are official builds (unmodified).
The OS (Operating System) and applications have no known unpatched or configuration vulnerabilities.
The system meets a high level of trust as defined by compliance regime X.

A modern worker seamlessly works across device types whether they are desktops, servers, mobile devices, corporate assets or BYOD (Bring Your Own Device). The only guarantee is they will use a device. A modern worker could be nomadic, working from home, the office or on the road. They are often Internet connected. Workers get work done by using applications whether they are local applications, cloud hosted applications, SaaS applications or premise hosted applications. The application access can be gated by an Identity Provider.

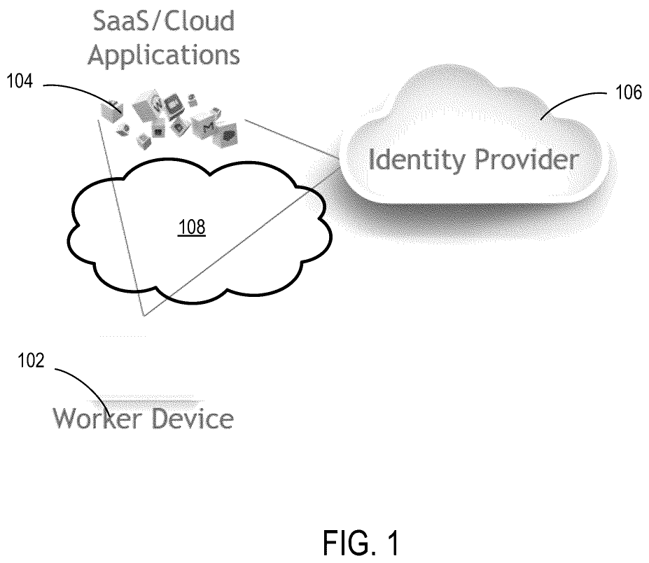

FIG. 1 is a diagram illustrating a typical prior art user work environment. A user or worker device 102 attempts to access SaaS (Software as a Service) or Cloud Applications 104. The access is referred to an identity provider 106 to verify that the user has access rights. The access rights can be simply checking the user name and password, or also determining whether the user has been granted access rights by an administrator.

The following security functions are typically provided. Identity—knowing assets and relationships. Protect—ensuring assets are protected (up to date patches, best common practice configurations, etc.). Ensuring relationships are authorized (principle of least privilege, etc.). Detect—knowing when a security incident first begins, or knowing when an incident that could lead to a security incident begins. Respond—being able to take corrective action when incidents are detected. Repair—resolving any damage caused by the incident as well as fix any root cause problems that lead to the incident.

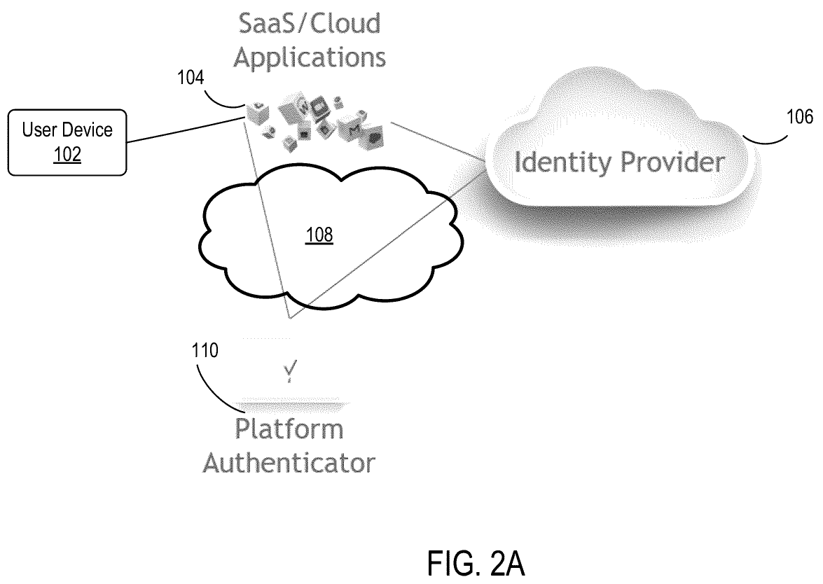

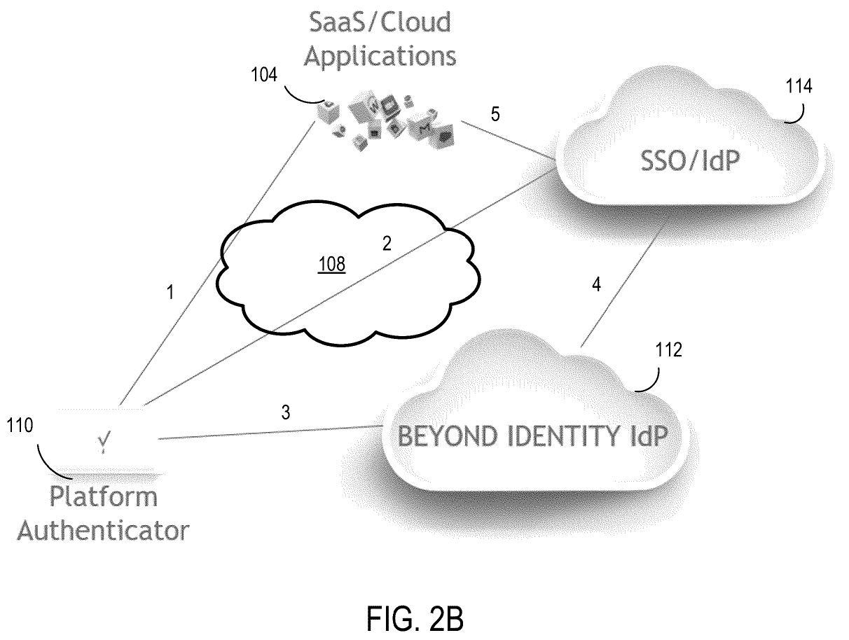

FIG. 2A is a diagram illustrating a remote user work environment with an added platform authenticator according to an embodiment. In this embodiment, the Identity Provider 106 sits in the middle of every worker transaction whether they are accessing a program or retrieving data. The Identity provider doesn't mind the variability in device, network, location or service accessed. A Platform Authenticator 110 is added to check the access authorization in the user device certificate. The Platform Authenticator 110 enables the following security features:
1. Identity Verification. Verify the Identity and authenticate the user driving the transaction.
2. Security Posture. Report on the current security posture of the device being used by the worker to access the application and/or retrieve data.
3. Authorization. Determine if the level of trust in identity and authentication along with the security posture of the device is sufficient to carry out the requested application access or data retrieval.
4. Log. Record a tamper proof log of the entire event that represents this transaction for future forensics, audit and data science applications.
5. Passwordless. Disaggregate risk and eliminate the movement and storage of shared secrets. Eliminate the primary vector of most security incidents.
6. Hardware Protection. Leverage modern hardware's ability to protect asymmetric crypto keys. Ensure keys are pinned to devices.
7. Credential Integrity. Cryptographically guarantee key relationships with identities, devices and their authorizations. Eliminate the potential of Insider data manipulation.
8. Flexible Policy. Tailor identity and device authentication mitigations to the specific risk of your environment.
9. Diagnostics & Incident Prevention. Provide analytics insights that help administrators quickly diagnose problems and suggest new policies that would result in incident prevention.

In embodiments, the following operations are supported:
1. Simple Identity Integration. Integrate with existing applications using standard authentication delegation protocols: SAML, OAUTH, OIDC, WS-FED, etc.
2. Automated Directory Integration. Integrate with common directory solutions using standard automation interfaces: SCIM, API(s), etc.
3. Data Export Integration. Integrate with standard data warehousing, log stores and SIEM: AWS S3, Snowflake, Kafka, Splunk, etc.

In embodiments, the following benefits are provided:
1. Low Friction. No user interaction necessary, unless desired by security administrators. No usage of legacy passwords or shared secrets.
2. Low Risk. No usage of shared secrets that can be exploited against the user (ATO, credential stuffing, etc.).
3. Seamless Operation. Work seamlessly across all platforms a modern worker uses: Windows, MacOS, iOS, Android, ChromeOS and Linux. Additionally work across all workloads: physical machines, local virtual machines and cloud virtual machines.

FIG. 2B is a diagram illustrating the remote user work environment of FIG. 2 with a Single Sign-On (SSO) provider according to an embodiment. SaaS/Cloud Applications 104 are applications used by a workforce and protected by an SSO/IdP (Identity Provider) 114. The SSO/IdP 114 is a single sign on provider serving delegated authentication and authorization for 3^{rd} party applications. A Beyond Identity IdP 112 is a cloud native delegate identity provider SSO(s) that can federate/delegate authentication. A Beyond Identity Platform Authenticator 110 is an authenticator program downloaded to be local to a workers device, that provides security posture, identity verification and authentication services.

The process followed by the embodiment of FIG. 2B is as follows, with the numbers of the steps corresponding to the lines on FIG. 2B.
1. End user accesses and application and is redirected for authentication to the SSO.
2. SSO determines the end user is served by Beyond Identity and delegates authentication.
3. Beyond Identity determines security risk of the device, trust level of identity claimed, criticality of application accessed and renders an authorization.
4. SSO obtains the identity and authorization from Beyond Identity.
5. Application obtains identity from the SSO.

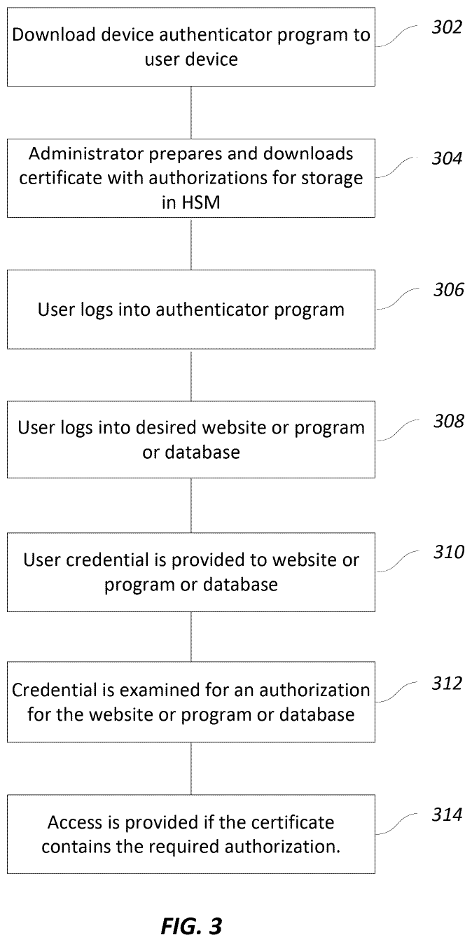

FIG. 3 is a flowchart illustrating the assignment of authorizations to a user certificate according to an embodiment. The first step is to download a device authenticator program to a user device (step 302). There is a certificate signing process where the ID, authorizations and obligations certificate is signed by the signing authority (the CA or a relying application). The certificate that will be signed by a CA (Certificate Authority) or a trusted service, is generated by the PA (Platform Authenticator) and submitted along with proof of ownership of the private key. This certificate is augmented with the ID, authorizations and obligations in the certificate extension fields and is signed by the CA. The ID, authorizations and obligations are requested by the Platform Authority in the CSR (Certificate Signing Request) in one embodiment. The signing authority verifies and possibly modifies those prior to issuing a signed certificate. The result is the downloaded certificate which is stored in the device HSM (304). The user can thereafter log into the local authenticator program (306), and then log into the desired website or program or database (308). The user credential is provided to the website or program or database by the authenticator program on the user device (310). The credential is examined for an authorization for the website or program or database (312). Access is provided if the certificate contains the required authorization (314).

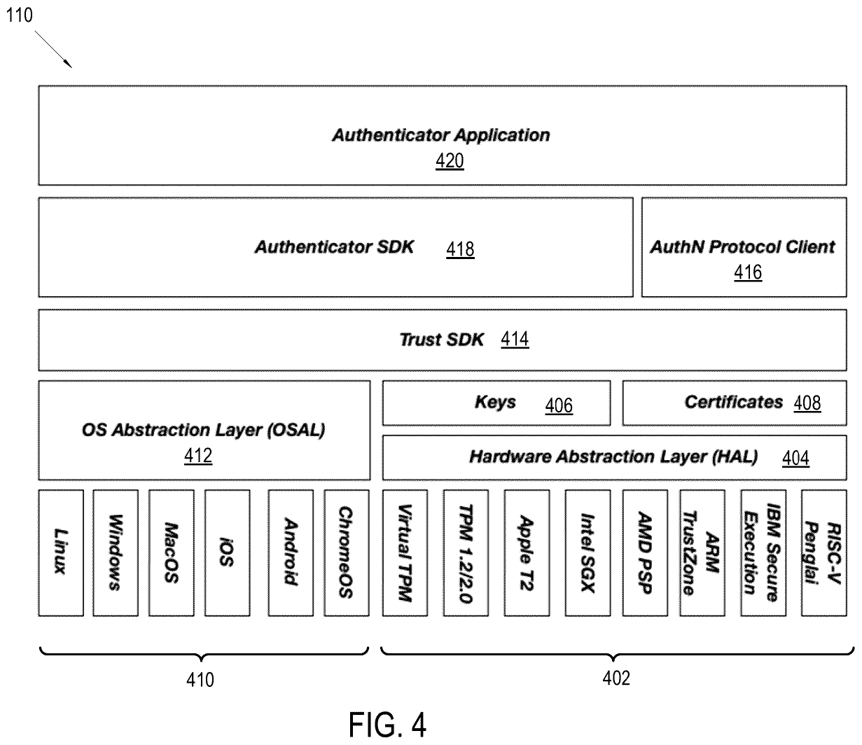

FIG. 4 is a diagram illustrating the components of platform authenticator 110 according to an embodiment. The platform authenticator provides a simple and intuitive user interaction. It manages the lifecycle of user identities and provides application access. It provides a range of identity and authentication trust levels. It manages all credentials using hardware to guarantee protection of cryptographic material. It provides security posture reporting. In particular, it proves the security posture of the device is adequate for the criticality of the application being accessed or data being retrieved. It also provides seamless operation since it runs on the diverse hardware and operating system options used by modern workers.

Platform Authenticator 110 has a group of trusted execution environment (TTE) adapters 402. The trust model is based on anchoring asymmetric crypto keys in hardware enclaves or TEE(s) 402. Additionally, the TEEI can help in making trusted assertions. In devices where no hardware TEE is available, TPM2 semantics can be emulated, but without hardware trust. This is useful for development, testing and certain low trust production scenarios.

The specifics of the various TEE semantics are abstracted through a Hardware Abstraction Layer (HAL) 404. This provides a stable library for development. Extending capabilities to new TEE models involves writing an adapter for the specific TEE. Examples of adaptors supported are: TPM, vTPM and Apple T2.

A thin library of keys in a crypto key library 406 uses the TEE HAL 404 to provide simple full life cycle management for cryptographic key material. This includes the typical operations: create, delete, sign, verify, encrypt and decrypt.

A certificate library 408 is a thin library which uses the TEE HAL 404 and the Keys library 406 to provide simple life cycle management for different types of credentials and their operations. The types of credentials include: x.509, ssh-certificate, JWT and PGP. The operations include: create, delete, endorse and verify.

Operating System (OS) security posture adaptors 410 provide security posture attestations over a wide distribution of system types.

OS Security Posture Abstraction Layer 412 provides a common interface for querying specific operating system properties.

Trust assertions library 414 leverages the underlying systems to make trusted assertions about both security posture and key usage authorizations.

An Authentication Protocol Client library 416 implements the specifics of the authentication and authorization protocol exchanges with the cloud.

The Authenticator SDK 418 is a library that uses both the Authentication Protocol Client Library 416 and the Trust SDK 414 to provide for common workflows a user may wish to authenticate.

The authenticator application 420 is a standalone program that is used to authenticate and gain authorization to access services and retrieve data. It may be run as a command line program or as an interactive program with a UI from a desktop environment.

### Authenticators on Virtual Machines

In one embodiment, an authenticator is implemented on a virtual machine. For a local virtual machine, this involves local development but remote administration. The development and integration testing is done with authenticator libraries. Examples of VM Vendors are VMWare, VirtualBox, Parallels, Xen, Hyper-V and QEMU.

In one embodiment, an authenticator is implemented on a remote/cloud virtual machines. This involves remote development, remote administration and a remote desktop (VDI). This also involves development and integration testing with authenticator libraries. Examples of VM Vendors are Amazon AWS EC2, Microsoft Azure Virtual Machines, Google Cloud Compute Engines, IBM Cloud Virtual Servers and Oracle Cloud Virtual Machines.

### Certificate

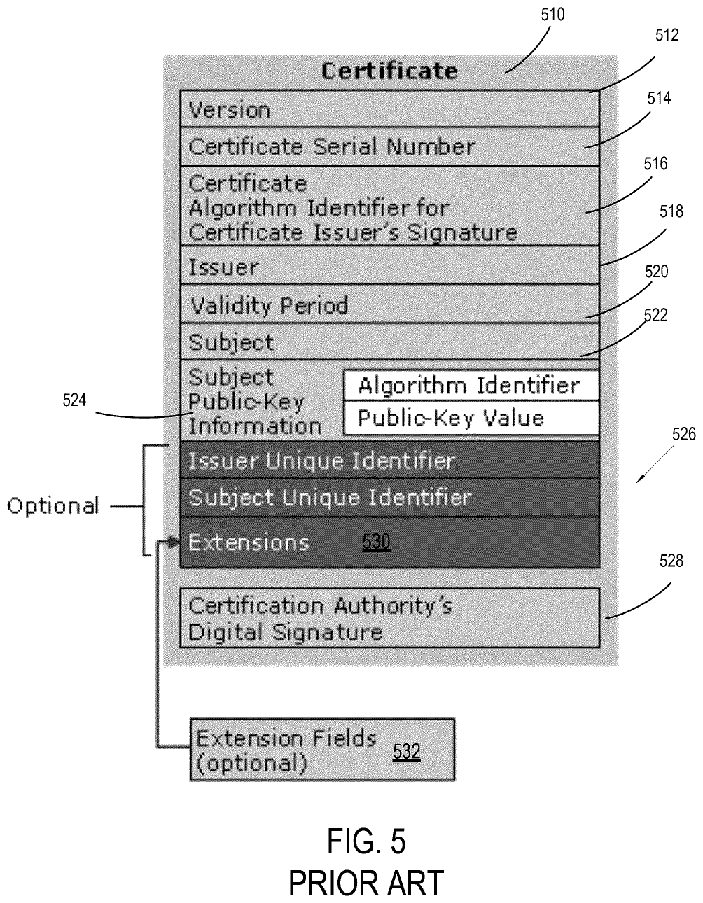

FIG. 5 is a diagram illustrating the fields of a standard X.509 certificate according to an embodiment. Standard certificate fields are used in one embodiment, but are populated differently. Certificate 510 contains a version field 512, a certificate serial number 514, and a Certificate algorithm identifier field 516 (describing how the certificate contents were hashed, and the algorithm used to sign the hash). An issuer field 518 is for a copy of the subject field of the certificate that signed.

Field 520 is a validity period, which would set forth the expiration date of the certificate. A subject field 522 is used to describe a company or organization, with its location, phone number, address, email, etc. Field 524 contains the public key information, with an algorithm identifier and a public-key value. This will be a different public key for each certificate. Optional and extension fields 526 can include a variety of data, including identifying whether the certificate is an intermediate certificate or a leaf certificate. Field 528 includes the Certification Authority's Digital Signature. Extensions 530 contains a series of optional extension fields 532. Embodiments of the invention use these fields to store the various authorizations.

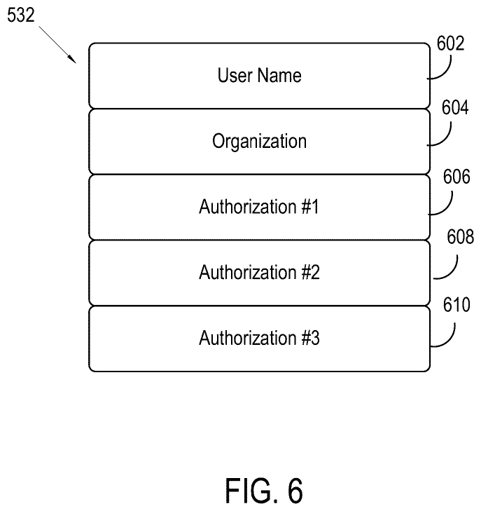

FIG. 6 is a diagram of the certificate extension fields storing authorizations and other organization data. A user name is provided in extension field 602. The organization name can be provided in extension field 604. If subject field 522 is used for this, extension field can be used for a sub-group of the organization to which the user belongs, or other information used to tag and identify the type of user (e.g., IT, human resources, etc.) which would affect the type of authorizations granted. Extension fields 606, 608 and 610 can provide additional authorizations. Although three are shown, many more can be used. In embodiments, for certificate implementations that have practical limits on the number of fields, multiple certificates can be provided for the roles that a user is taking on and the correct certificate (or the entire set) is provided.

Because a user name is provided in extension field 602, the certificate provides identity protection in addition to authorizations. The challenge/response attestation proves that the user holds the private key associated with the certificate and thus attests to the claimed identity. While a device key presumably is associated with a user, a certificate according to the present invention can tie a user identity to a device ID in the certificate, and thus in the certificate key. Additionally, the relationship between the identity and the authorizations is protected by the certificate.

### Certificate Creation.

In one embodiment, a certificate is created by either the entity administrator or the authenticator identity provider. The administrator can provide a list of authorizations to the identity provider, along with the user name and other identifying information. This process is rooted in the policy engine in one embodiment:
P({device profile}, {identity}, [requested authorizations])->{allow, [granted authorizations], [obligations]}|{deny, reason}

The decision flow is provided by an ID. This can be triggered via an authentication flow or via an administrative action that launches the CSR (Certificate Signing Request) process with the PA (Platform Authenticator).

In one embodiment, a single certificate could have authorizations for multiple assets. Alternately, each authorization can have its own certificate. In another embodiment, a single certificate is used for a single digital asset, which may have multiple authorizations (access, write authorization, download authorization, copy authorization, etc.). Also, single use certificates can be issued, or the certificate could have a fixed termination date, or no real termination date (by writing a very distant date in the validity period field 520 of FIG. 5).

In one embodiment, certificate holder could be authorized to create additional certificates. The authorization could be limited in many ways, such as to a subset of the authorizations the certificate holder has, or to issuing only single use sub-certificates. In one embodiment, the holder would sign another certificate (new key) adding to the chain.

### Normalization Engine.

The normalization and the unification of credential types is done as follows in one embodiment. The authorizations are mapped into the specific certificate formats via extensions and/or options. The specific authorizations and obligations formats contained within these fields are mapped into and out of the extensions via translation layers (shim libraries) that abstract the details of the certificate format (carrier) from the content.

### Change of Authorization.

Since, once written, the certificate cannot be changed without causing a tampering flag, authorizations are not revised in the certificate. If a user no longer has authorization to access an asset, the certificate is canceled and a new certificate is issued. In a trusted PA situation, the certificate is essentially overwritten. In an untrusted PA situation or when an overwrite is not feasible a revocation list can be employed. A single certificate could have authorizations for multiple assets, and thus all the unchanged authorizations need to be rewritten as well.

### Types of Controls.

In addition to access controls, authorizations may be used for certain actions. For example, no access control may be needed for a database, but the ability to write, copy, download, change, etc. may require authorization.

### Computer Systems for Media Platform and Client System

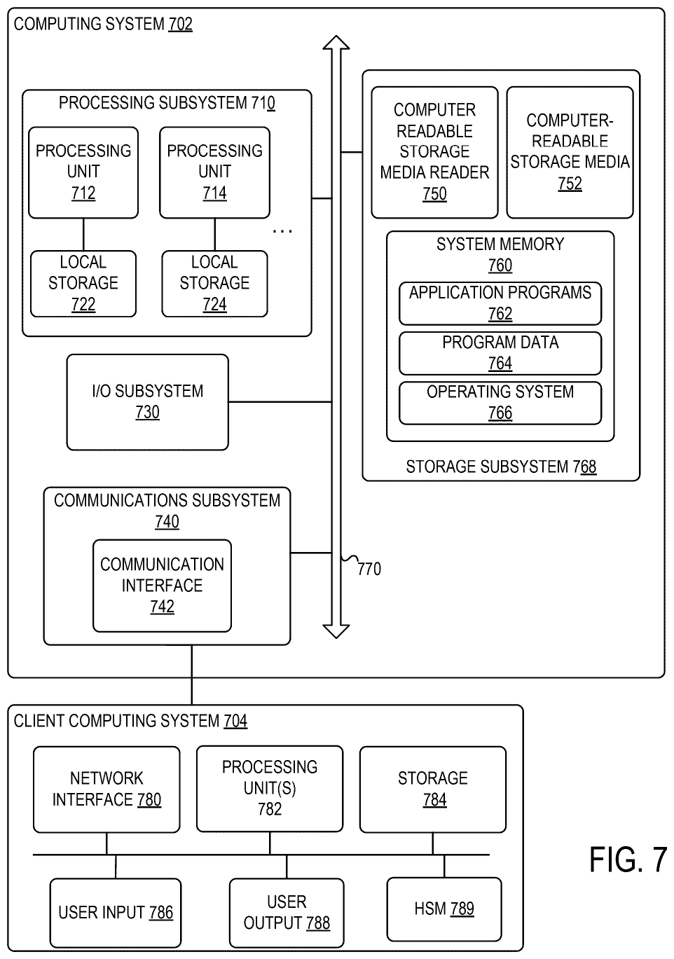

Various operations described herein may be implemented on computer systems. FIG. 7 shows a simplified block diagram of a representative computing system 702 and client computing system 704 usable to implement certain embodiments of the present invention. In various embodiments, computing system 702 or similar systems may implement the server or website computing system or other verifying party, or any other computing system described herein or portions thereof. Client computing system 704 or similar systems may implement user devices such as a smartphone, tablet, computer, smart watch, or other devices.

Computing system 702 may be one of various types, including processor and memory, a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Computing system 702 may include processing subsystem 710. Processing subsystem 710 may communicate with a number of peripheral systems via bus subsystem 770. These peripheral systems may include I/O subsystem 730, storage subsystem 768, and communications subsystem 740.

Bus subsystem 770 provides a mechanism for letting the various components and subsystems of server computing system 704 communicate with each other as intended. Although bus subsystem 770 is shown schematically as a single bus, alternative embodiments of the bus subsystem may utilize multiple buses. Bus subsystem 770 may form a local area network that supports communication in processing subsystem 710 and other components of server computing system 702. Bus subsystem 770 may be implemented using various technologies including server racks, hubs, routers, etc. Bus subsystem 770 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

I/O subsystem 730 may include devices and mechanisms for inputting information to computing system 702 and/or for outputting information from or via computing system 702. In general, use of the term “input device” is intended to include all possible types of devices and mechanisms for inputting information to computing system 702. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computing system 702 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Processing subsystem 710 controls the operation of computing system 702 and may comprise one or more processing units 712, 714, etc. A processing unit may include one or more processors, including single core processor or multicore processors, one or more cores of processors, or combinations thereof. In some embodiments, processing subsystem 710 may include one or more special purpose co-processors such as graphics processors, digital signal processors (DSPs), or the like. In some embodiments, some or all of the processing units of processing subsystem 710 may be implemented using customized circuits, such as application specific integrated circuits (ASICs), or field programmable gate arrays (FPGAs). In some embodiments, such integrated circuits execute instructions that are stored on the circuit itself. In other embodiments, processing unit(s) may execute instructions stored in local storage, e.g., local storage 722, 724. Any type of processors in any combination may be included in processing unit(s) 712, 714.

In some embodiments, processing subsystem 710 may be implemented in a modular design that incorporates any number of modules (e.g., blades in a blade server implementation). Each module may include processing unit(s) and local storage. For example, processing subsystem 710 may include processing unit 712 and corresponding local storage 722, and processing unit 714 and corresponding local storage 724.

Local storage 722, 724 may include volatile storage media (e.g., conventional DRAM, SRAM, SDRAM, or the like) and/or nonvolatile storage media (e.g., magnetic or optical disk, flash memory, or the like). Storage media incorporated in local storage 722, 724 may be fixed, removable or upgradeable as desired. Local storage 722, 724 may be physically or logically divided into various subunits such as a system memory, a ROM, and a permanent storage device. The system memory may be a read and write memory device or a volatile read and write memory, such as dynamic random access memory. The system memory may store some or all of the instructions and data that processing unit(s) 712, 714 need at runtime. The ROM may store static data and instructions that are needed by processing unit(s) 712, 714. The permanent storage device may be a nonvolatile read and write memory device that may store instructions and data even when a module including one or more processing units 712, 714 and local storage 722, 724 is powered down. The term “storage medium” as used herein includes any medium in which data may be stored indefinitely (subject to overwriting, electrical disturbance, power loss, or the like) and does not include carrier waves and transitory electronic signals propagating wirelessly or over wired connections.

In some embodiments, local storage 722, 724 may store one or more software programs to be executed by processing unit(s) 712, 714, such as an operating system and/or programs implementing various server functions such as functions of UPP system 102, or any other server(s) associated with UPP system 102. “Software” refers generally to sequences of instructions that, when executed by processing unit(s) 712, 714 cause computing system 702 (or portions thereof) to perform various operations, thus defining one or more specific machine implementations that execute and perform the operations of the software programs. The instructions may be stored as firmware residing in read-only memory and/or program code stored in nonvolatile storage media that may be read into volatile working memory for execution by processing unit(s) 712, 714. In some embodiments the instructions may be stored by storage subsystem 768 (e.g., computer readable storage media). In various embodiments, the processing units may execute a variety of programs or code instructions and may maintain multiple concurrently executing programs or processes. At any given time, some or all of the program code to be executed may be resident in local storage 722, 724 and/or in storage subsystem including potentially on one or more storage devices. Software may be implemented as a single program or a collection of separate programs or program modules that interact as desired. From local storage 722, 724 (or nonlocal storage described below), processing unit(s) 712, 714 may retrieve program instructions to execute and data to process in order to execute various operations described above.

Storage subsystem 768 provides a repository or data store for storing information that is used by computing system 702. Storage subsystem 768 provides a tangible non-transitory computer-readable storage medium for storing the basic programming and data constructs that provide the functionality of some embodiments. Software (programs, code modules, instructions) that when executed by processing subsystem 710 provide the functionality described above may be stored in storage subsystem 768. The software may be executed by one or more processing units of processing subsystem 710. Storage subsystem 768 may also provide a repository for storing data used in accordance with the present invention.

Storage subsystem 768 may include one or more non-transitory memory devices, including volatile and non-volatile memory devices. As shown in FIG. 7, storage subsystem 768 includes a system memory 760 and a computer-readable storage media 752. System memory 760 may include a number of memories including a volatile main RAM for storage of instructions and data during program execution and a non-volatile ROM or flash memory in which fixed instructions are stored. In some implementations, a basic input/output system (BIOS), containing the basic routines that help to transfer information between elements within computing system 702, such as during start-up, may typically be stored in the ROM. The RAM typically contains data and/or program modules that are presently being operated and executed by processing subsystem 710. In some implementations, system memory 760 may include multiple different types of memory, such as static random access memory (SRAM) or dynamic random access memory (DRAM). Storage subsystem 768 may be based on magnetic, optical, semiconductor, or other data storage media. Direct attached storage, storage area networks, network attached storage, and the like may be used. Any data stores or other collections of data described herein as being produced, consumed, or maintained by a service or server may be stored in storage subsystem 768.

By way of example, and not limitation, as depicted in FIG. 7, system memory 760 may store application programs 762, which may include client applications, Web browsers, mid-tier applications, relational database management systems (RDBMS), etc., program data 764, and one or more operating systems 766. By way of example, an example operating systems may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 752 may store programming and data constructs that provide the functionality of some embodiments. Software (programs, code modules, instructions) that when executed by processing subsystem 710 a processor provide the functionality described above may be stored in storage subsystem 768. By way of example, computer-readable storage media 752 may include non-volatile memory such as a hard disk drive, a magnetic disk drive, an optical disk drive such as a CD ROM, DVD, a Blu-Ray® disk, or other optical media. Computer-readable storage media 752 may include, but is not limited to, Zip® drives, flash memory cards, universal serial bus (USB) flash drives, secure digital (SD) cards, DVD disks, digital video tape, and the like. Computer-readable storage media 752 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 752 may provide storage of computer-readable instructions, data structures, program modules, and other data for computing system 702.

In certain embodiments, storage subsystem 768 may also include a computer-readable storage media reader 750 that may further be connected to computer-readable storage media 752. Together and, optionally, in combination with system memory 760, computer-readable storage media 752 may comprehensively represent remote, local, fixed, and/or removable storage devices plus storage media for storing computer-readable information.

In certain embodiments, computing system 702 may provide support for executing one or more virtual machines. Computing system 702 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computing system 702. Accordingly, multiple operating systems may potentially be run concurrently by computing system 702. Each virtual machine generally runs independently of the other virtual machines.

Communication subsystem 740 provides an interface to other computer systems and networks. Communication subsystem 740 serves as an interface for receiving data from and transmitting data to other systems from computing system 702. For example, communication subsystem 740 may enable computing system 702 to establish a communication channel to one or more client computing devices via the Internet for receiving and sending information from and to the client computing devices.

Communication subsystem 740 may support both wired and/or wireless communication protocols. For example, in certain embodiments, communication subsystem 740 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communication subsystem 740 may provide wired network connectivity (e.g., Ethernet) in addition to or instead of a wireless interface.

Communication subsystem 740 may receive and transmit data in various forms. For example, in some embodiments, communication subsystem 740 may receive input communication in the form of structured and/or unstructured data feeds, event streams, event updates, and the like. For example, communication subsystem 740 may be configured to receive (or send) data feeds in real-time from users of social media networks and/or other communication services such as Twitter® feeds, Facebook® updates, web feeds such as Rich Site Summary (RSS) feeds, and/or real-time updates from one or more third party information sources.

In certain embodiments, communication subsystem 740 may be configured to receive data in the form of continuous data streams, which may include event streams of real-time events and/or event updates, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communication subsystem 740 may also be configured to output the structured and/or unstructured data feeds, event streams, event updates, and the like to one or more databases that may be in communication with one or more streaming data source computers coupled to computing system 702.

Communication subsystem 740 may provide a communication interface 742, e.g., a WAN interface, which may provide data communication capability between the local area network (bus subsystem 770) and a larger network, such as the Internet. Conventional or other communications technologies may be used, including wired (e.g., Ethernet, IEEE 802.3 standards) and/or wireless technologies (e.g., WiFi, IEEE 802.11 standards).

Computing system 702 may operate in response to requests received via communication interface 742. Further, in some embodiments, communication interface 742 may connect computing systems 702 to each other, providing scalable systems capable of managing high volumes of activity. Conventional or other techniques for managing server systems and server farms (collections of server systems that cooperate) may be used, including dynamic resource allocation and reallocation.

Computing system 702 may interact with various user owned or user operated devices via a wide area network such as the Internet. An example of a user operated device is shown in FIG. 7 as client computing system 702. Client computing system 704 may be implemented, for example, as a consumer device such as a smart phone, other mobile phone, tablet computer, wearable computing device (e.g., smart watch, eyeglasses), desktop computer, laptop computer, and so on.

For example, client computing system 704 may communicate with computing system 702 via communication interface 742. Client computing system 704 may include conventional computer components such as processing unit(s) 782, storage device 784, network interface 780, user input device 786, and user output device 788. Client computing system 704 also includes a Hardware Security Module (HSM) 789. Client computing system 704 may be a computing device implemented in a variety of form factors, such as a desktop computer, laptop computer, tablet computer, smart phone, other mobile computing device, wearable computing device, or the like.

Processing unit(s) 782 and storage device 784 may be similar to processing unit(s) 712, 714 and local storage 722, 724 described above. Suitable devices may be selected based on the demands to be placed on client computing system 704; for example, client computing system 704 may be implemented as a “thin” client with limited processing capability or as a high powered computing device. Client computing system 704 may be provisioned with program code executable by processing unit(s) 782 to enable various interactions with computing system 702 of a message management service such as accessing messages, performing actions on messages, and other interactions described above. Some client computing systems 704 may also interact with a messaging service independently of the message management service.

Network interface 780 may provide a connection to a wide area network (e.g., the Internet) to which communication interface 740 of computing system 702 is also connected. In various embodiments, network interface 780 may include a wired interface (e.g., Ethernet) and/or a wireless interface implementing various RF data communication standards such as WiFi, Bluetooth®, or cellular data network standards (e.g., 3G, 4G, LTE, etc.).

User input device 786 may include any device (or devices) via which a user may provide signals to client computing system 704; client computing system 704 may interpret the signals as indicative of particular user requests or information. In various embodiments, user input device 786 may include any or all of a keyboard, touch pad, touch screen, mouse or other pointing device, scroll wheel, click wheel, dial, button, switch, keypad, microphone, and so on.

User output device 788 may include any device via which client computing system 704 may provide information to a user. For example, user output device 788 may include a display to display images generated by or delivered to client computing system 704. The display may incorporate various image generation technologies, e.g., a liquid crystal display (LCD), light emitting diode (LED) including organic light emitting diodes (OLED), projection system, cathode ray tube (CRT), or the like, together with supporting electronics (e.g., digital to analog or analog to digital converters, signal processors, or the like). Some embodiments may include a device such as a touchscreen that function as both input and output device. In some embodiments, other user output devices 788 may be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification may be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher level code that are executed by a computer, an electronic component, or a microprocessor using an interpreter. Through suitable programming, processing unit(s) 712, 714 and 782 may provide various functionality for computing system 702 and client computing system 704, including any of the functionality described herein as being performed by a server or client, or other functionality associated with message management services.

It will be appreciated that computing system 702 and client computing system 704 are illustrative and that variations and modifications are possible. Computer systems used in connection with embodiments of the present invention may have other capabilities not specifically described here. Further, while computing system 702 and client computing system 704 are described with reference to particular blocks, it is to be understood that these blocks are defined for convenience of description and are not intended to imply a particular physical arrangement of component parts. For instance, different blocks may be but need not be located in the same facility, in the same server rack, or on the same motherboard. Further, the blocks need not correspond to physically distinct components. Blocks may be configured to perform various operations, e.g., by programming a processor or providing appropriate control circuitry, and various blocks might or might not be reconfigurable depending on how the initial configuration is obtained. Embodiments of the present invention may be realized in a variety of apparatus including electronic devices implemented using any combination of circuitry and software.

While the invention has been described with respect to specific embodiments, one skilled in the art will recognize that numerous modifications are possible. Embodiments of the invention may be realized using a variety of computer systems and communication technologies including but not limited to specific examples described herein.

Embodiments of the present invention may be realized using any combination of dedicated components and/or programmable processors and/or other programmable devices. The various processes described herein may be implemented on the same processor or different processors in any combination. Where components are described as being configured to perform certain operations, such configuration may be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer readable storage medium).

Thus, although the invention has been described with respect to specific embodiments, it will be appreciated that the invention is intended to cover all modifications and equivalents within the scope of the following claims.

What is claimed is:

1. A method for authenticating a user to a verifying party computer over a network, comprising:
preparing an access authorization for an access controlled digital asset to the authenticator program;
writing the access authorization in a field of a digital certificate;
storing the digital certificate as a non-alterable entry in a hardware security module of the user device;
requesting access to the access controlled digital asset by the user device; and
providing the access authorization from the digital certificate to the access controlled digital asset.

2. The method of claim 1 further comprising:
writing a user name in a field of the digital certificate; and
writing the access authorization in an extension field of the digital certificate.

3. The method of claim 1 wherein the access controlled digital asset is one of a program, website or database.

4. The method of claim 1 wherein the digital certificate is one of an X.509, SSH, OpenPGP or SPKI certificate.

5. The method of claim 1 further comprising:
mapping the access authorization into a specific certificate format via extensions or options using a translation layer to abstract the details of the specific certificate format from the content.

6. The method of claim 1 further comprising writing a user identifier and obligations associated with the access authorization to the digital certificate.

7. The method of claim 1 wherein an associated private key is stored in the hardware security module with the digital certificate, the private key not being readable after storage.

8. The method of claim 7 further comprising issuing a challenge to the user device and receiving a response signed by the private key to attest to a user identity stored in the digital certificate.

9. The method of claim 1 further comprising:
providing a second access authorization for a second access controlled digital asset to the authenticator program; and
writing the second access authorization in a field of the digital certificate or a second digital certificate.

10. The method of claim 1 wherein the access authorization is included in a certificate signing request sent to a signing authority.

11. A method for authenticating a user to a verifying party computer over a network, comprising:
preparing an access authorization for an access controlled digital asset to the authenticator program;
mapping the access authorization into a specific certificate format via extensions or options using a translation layer to abstract the details of the specific certificate format from the content;
including the access authorization in a certificate signing request sent to a signing authority;
writing the access authorization in a field of a digital certificate;
writing a user name in a field of the digital certificate;
writing the access authorization in an extension field of the digital certificate;
storing the digital certificate as a non-alterable entry in a hardware security module of the user device;
requesting access to the access controlled digital asset by the user device; and
providing the access authorization from the digital certificate to the access controlled digital asset;
wherein the access controlled digital asset is one of a program, website or database;
wherein the digital certificate is one of an X.509, SSH, OpenPGP or SPKI certificate.

12. A non-transitory computer-readable medium having stored thereon instructions that, when executed by one or more processors, cause the one or more processors to perform operations including:
preparing an access authorization for an access controlled digital asset to the authenticator program; and
including the access authorization in a certificate signing request sent to a signing authority over a network.

13. A system for authenticating a user to a verifying party computer over a network, comprising:
a platform authenticator processor configured to prepare an access authorization for an access controlled digital asset to the authenticator program and include the access authorization in a certificate signing request sent to a signing authority over a network;
a signing authority processor configured to write the access authorization in a field of a digital certificate; and
a user device processor configured to
receive the digital certificate over the network and store the digital certificate as a non-alterable entry in a hardware security module of the user device, and
request access to the access controlled digital asset by the user device.

14. The system of claim 13 wherein the signing authority processor is further configured to:
write a user name in a field of the digital certificate; and
write the access authorization in an extension field of the digital certificate.

15. The system of claim 13 wherein the access controlled digital asset is one of a program, website or database.

16. The system of claim 13 wherein the digital certificate is one of an X.509, SSH, OpenPGP or SPKI certificate.

17. The system of claim 13 wherein the platform authenticator processor is further configured to:
map the access authorization into a specific certificate format via extensions or options using a translation layer to abstract the details of the specific certificate format from the content.

18. The system of claim 13 wherein the user device processor is further configured to store an associated private key in the hardware security module with the digital certificate, the private key not being readable after storage.

19. The system of claim 13 wherein the platform authenticator processor is further configured to:
issue a challenge to the user device processor and receive a response signed by the private key to attest to a user identity stored in the digital certificate.

20. The system of claim 13 wherein the platform authenticator processor is further configured to:
provide a second access authorization for a second access controlled digital asset to the authenticator program; and
include the second access authorization in a second certificate signing request sent to a signing authority over the network.
